(19) United States
(12) Patent Application Publication
(10) Pub. No.: US 2006/0192655 A1
(43) Pub. Date: Aug. 31, 2006

(54) Radio frequency identification of tagged articles

(76) Inventor: Eduard Levin, Thornhill (CA)

Correspondence Address: DAVID W. WONG, 46 WILLOWBROOK ROAD, THORNHILL, ON, L3T 4W9, CA

(21) Appl. No.: 11/355,219

(22) Filed: Feb. 16, 2006

(30) Foreign Application Priority Data
Feb. 28, 2005 (CA) 2,497,629

(51) Int. Cl. H04Q 5/22

(52) U.S. Cl. 340/10.2; 340/825.49; 340/572.1

(57) ABSTRACT

The RFID system is for automatic recognition of each one or all of a plurality of objects located within an interrogation zone. It is applicable for stock-taking or control of goods such as food. The objects provided with tags having transponders carrying RFID codes individually are sequentially scanned and activated one by one. Interrogation signals are transmitted to the tags based on the reader antennas and the configurations and locations of the tags. Signals returned from the transponders of the tags are processed for recognizing the locations of the selected tags and the electronic contents of the tags. The operation continues until the recognition and location of all tags in the entire interrogation zone have been completed.

### BACKGROUND OF THE INVENTION

1. Field of the Invention

This invention relates to systems of maintaining the inventory of objects provided with radio-frequency transducers such as tags or transponders containing electronic codes for their recognition. Such devices are commonly known as radio frequency identification devices (RFID). More specifically, this invention relates to radio-frequency methods of spatial resolution of tags, RFID tag and tag activation device. A RFID consists of a reader and transponders; the latter are affixed on objects which are subject to inventory and are located in a storage such as a warehouse.

2. Description of Prior Art

RFID methods and systems provide the recognition of objects with identification tags affixed thereon. The process of tag recognition must be accomplished at high speed and with minimum error. In this process it is necessary to determine the tag location or direction relative to a reader.

Each RFID consists of a reader and a transponder with the latter affixed on the object subject to inventory. Readers are provided for primarily reading tag codes and, some of them, searching for tag direction only. The reader transmits a tag activation signal for all tags in the interrogation zone simultaneously, and adjusts the activation signal which has been sent in advance to the tags with known codes. Tags activated in such a manner transmit response signals which carry information of tag electronic codes. These signals reach the reader practically simultaneously. For a small number of tags, for example, from one to five, because of the differences in electronic circuit parameters, tags are activated in an insignificant time lag, which allows a reader to read codes by activating tags repeatedly in order to increase the probability of codes recognition. When a larger number of tags are to be read by the readers, tag signals reach the reader practically simultaneously, which may result in failure to recognize the objects with adequate accuracy.

It is also very important to authenticate the tags in reading the memory content of each tag when a plurality of tags are located in the tag interrogation zone simultaneously. The RFID HANDBOOK by Klaus Finkenzeller, Carl Hansen Verlag, Munich/FRG, 1999 outlines four methods of solving the problem of space, frequency, code and time discriminations in RFID. U.S. Pat. No. 6,600,443 and U.S. Pat. No. 6,476,756 both to J. A Landt, and U.S. Pat. No. 6,069,564 to R. Hatano et al illustrate methods and systems of tag reading and determination of its direction. Both U.S. Pat. No. 6,600,443 and No. 6,476,756 to J. A. Landt illustrate a method of tag signal structure analysis while U.S. Pat. No. 6,069,564 by R. Hatano et al proposes a multi-directional RFID antennae for this purpose.

U.S. Pat. No. 6,034,603 to W. E. Steeves and U.S. Pat. No. 6,354,493 to J. Mon show technical solutions for reducing the probability of recognition error on the basis of selecting RFID tag search criteria, generation feedback signals according to the ratio of RFID tags matching the search criteria to the total number of RFID tags received.

U.S. Pat. No. 2,452,351 to H. L. Bloxom et al and Canadian Patent No. 2,437,888 describe tag reader systems and tag control and reading algorithms of signal processing for one or several readers.

Canadian patents No. 2,447.975 to P. M. Eisenberg et al, and No. 2,399,092, and No. 2,450,189 both to P. A. Sevcik et al describe aspects of collection and use of data obtained by RFID tag interrogation, in particular, by comparing information obtained through interrogation of tags with the data recorded during repeated interrogations.

U.S. Pat. No. 6,317,028 to C. Valinlis, U.S. Pat. No. 5,822,714 to R. T. Cato, U.S. Pat. No. 6,034,603 to W. E. Steeves and Canadian patent No. 2,447,975 to P. M. Eisenberg et al show RFID systems of tag recognition for the case of a plurality of radio frequency identification tags. To effectively recognise tags, a number of other technical solutions assume a tags' data base as previously known and perform its current status control through comparison of the read current values with the data of a base as shown in U.S. Pat. No. 5,822,714 to R. T. Cato. U.S. Pat. No. 6,034,603 to W. E. Steeves also shows such a method and system of tag construction with improved tag interference avoidance in which a tag includes both a receiver module and a processor, while the generation of a signal is decided as a result of analysis of radio frequency activity.

All of the above prior art patents fail to teach, or even suggest, any RFID method and system possessing features which can perform a recognition and locating functions in case of a plurality of objects, and reading the codes and locating tags of both single decoding or working simultaneously with large numbers of articles, under conditions of locating the inventory objects on the plane or in the random volume with minimization of errors caused by reflection of signals from surrounding surfaces.

### SUMMARY OF THE INVENTION

The principal object of the present invention is to provide recognition systems with radio frequency identification devices (RFID) and, more specifically, to provide radio frequency methods of three-dimensional tag selection, creation of tag activation devices and their algorithms as well as tag design.

The read range of the reader is determined according to dimensions of an interrogation zone and a search starting point, the tag's possible location is selected in the form of a small spatial domain namely a local interrogation zone. The reader starts transmitting tag activating signals through three spatially separated omnidirectional antennae. The time of each signal transmission is calculated in accordance with the tag's assumed location, which is being entered into the reader's memory. The signals are received by each of the tags, and only the tag for which the reader signals are calculated and transmitted according to the specific formulas, will be activated. The activated tag emits its own identification signal which carries the information about the individual tag code. This identification signal is received by the reader and a tag code is selected and entered into the reader's memory according to the preliminarily calculated tag location. Following the tag's assumed location having been selected, calculated, and entered into the readers' memory, the next signal sequence transmission will be calculated and the signals are transmitted through the reader's antennae, etc. The entire sequence is repeated for scanning the entire interrogation zone.

The invention possesses numerous benefits and advantages over known RFID systems. In particular, the invention permits the reduction of the time of search and recognition of tags when there are large numbers of tags to be recognized within an interrogation zone. It can locate each one of a plurality of objects and increases the probability of reading the codes without error. Noise immunity is increased due to the elimination of false responses when receiving signals are reflected from random surfaces such as the warehouse walls, shelves, adjacent articles, container surfaces, etc. One embodiment of the invention can be used with existing tags by providing only minor modifications of the input stages of the existing transponders. It may be used in a single-channel, or two-channel, or multi-channel systems. The universal character of the system allows it to be used as a mobile or a stationary device, as well as a two-dimensional or a three-dimensional space version.

As a whole, the present invention resolves the complex problem in object location and recognition both in cases of a single decoding, as well as with a large number of articles simultaneously located in an inventory object location in diverse conditions; and it is applicable in a wide variety of fields in manufacturing, shipping or storage.

The RFID method and system of the present invention are based on the implementation of a Tag Activator for creating specific signals which perform tag interrogation zone multi-step scanning, selected transponder activation, and processing the transponder signal by the reader for:

Determination of the total interrogation zone coordinates and writing them into the reader memory;
Determination of local interrogation zone start point coordinates and writing them into the reader memory;
Calculation of activation signal parameters for each reader antennae for assumed tag location, i.e. local interrogation zone;
Creating signals for tag activation—a tag activator coder;
Transmitting of signals by reader antennas;
Receiving of activation signals for processing by the tag activator decoder and making a decision if this tag supposed to be activated or not;
Creation a control signal by the tag activator decoder to activate transponder transmitter and transfer the electronic code of the tag to a reader;
The selected tag signal has been received by a reader, then the tag electronic code is retrieved from a signal and memorized by the reader, and the reader's memory keeps the tag coordinates, which are in fact the location of the object with a tag;
If in the course of time determined by search area range no response signal has been received, then the following step of search is performed by shifting the local interrogation zone on the coordinate off one step, which is determined by tag activator resolution;
Procedure of activation signals creation, transmitting and processing, tag signal receiving is repeated until the total interrogation zone is completely examined;
Tag electronic codes, their location and other tag information are indicated on the reader's data base and monitor.

### BRIEF DESCRIPTION OF THE DRAWINGS

FIG. 1 is a layout of tags location and two antennae transmitting the activating signals relating to concept of tag activation according to an embodiment of the present invention.

FIG. 2 is the signals emitted by two antennae of tag activator coder and received them by a tag relating to a concept of tag activation according to an embodiment of the present invention.

FIG. 3 is a block diagram of tag location decoder for a case referring to according to an embodiment of the present invention.

FIG. 4 is a layout of activated and non-activated tags and antennae of tag activator coder according to an embodiment of the present invention.

FIG. 5 is the signals transmitted by three antennae of tag activator coder and received by tag activator decoder operating according to concept of comparison of single pulses of the present invention according to an embodiment of the present invention.

FIG. 6 is a block diagram of tag activator decoder operating in accordance with the concept of comparison of single pulses according to an embodiment of the present invention.

FIG. 7 shows a principle of localization and activation of tags in total interrogation zone in two-dimensional Cartesian coordinates according to an embodiment of the present invention.

FIG. 8 shows a principle of localization and activation of tags in three-dimensional Cartesian coordinates according to an embodiment of the present invention.

FIG. 9 is the activating signals and tag activator decoder pulse trains operating according to concept of comparison of time intervals according to an embodiment of the present invention.

FIG. 10 shows the activating signals with different frequency carrier according to an embodiment of the present invention.

FIG. 11 is a block diagram of tag activator coder for activating signals with different carrier according to an embodiment of the present invention.

FIG. 12 is pulse train of activating signals according to an embodiment of the present invention.

FIG. 13 is the activating signals for a case of tag activation by pulses with randomized envelope according to an embodiment of the present invention.

FIG. 14. is a block diagram of tag activator decoder for a case of tag activation by pulse train according to an embodiment of the present invention.

FIG. 15. is a block diagram of tag activator decoder for a case of tag activation by pulses with randomized envelope according to an embodiment of the present invention.

FIG. 16 is the signals transmitted by tag activator coder with electronic access key according to an embodiment of the present invention.

FIG. 17. is a block diagram of tag activator decoder with electronic access key according to an embodiment of the present invention.

FIG. 18 is a flow chart of a tag activator coder and reader according to an embodiment of the present invention.

FIG. 19 is a block diagram of RFID Transponder with build-in tag activator decoder according to an embodiment of the present invention.

FIG. 20 is a block diagram of RFID reader with build-in tag activator coder according to an embodiment of the present invention.

FIG. 21 is a block diagram of Amplitude Shift Keying RFID transponder with build-in tag activator decoder according to an embodiment of the present invention.

FIG. 22 is a block diagram of Amplitude Shift Keying RFID reader with build-in tag activator decoder according to an embodiment of the present invention.

FIG. 23 is a block diagram of Amplitude Frequency Shift Keying tag with build-in tag activator decoder according to an embodiment of the present invention.

FIG. 24 is a block diagram of Amplitude Frequency Shift Keying RFID reader with build-in tag activator coder according to an embodiment of the present invention.

FIG. 25 is a block diagram of RFID transponder with build-in ultrasound tag activator decoder according to an embodiment of the present invention

FIG. 26 is a block diagram of RFID reader with build-in ultrasound tag activator coder according to an embodiment of the present invention

FIG. 27 is a block diagram of RFID transponder with build-in light activated tag activator decoder according to an embodiment of the present invention

FIG. 28 is a block diagram of RFID transponder with build-in light activated tag activator decoder according to an embodiment of the present invention.

FIG. 29 is a block diagram of Amplitude Shift Keying RFID transponder with build-in tag activator decoder according to an embodiment of the present invention.

### DETAILED DESCRIPTION OF THE PREFERRED EMBODIMENTS

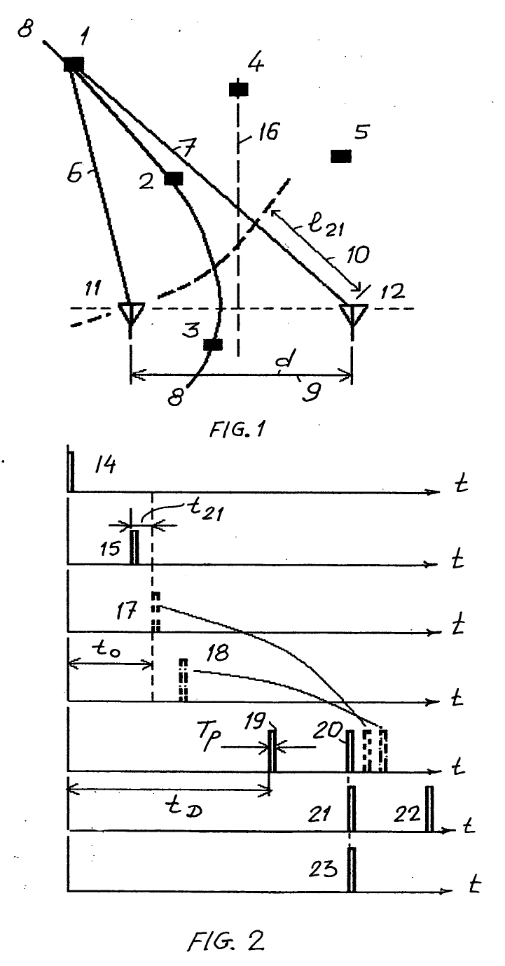

With reference to the drawings, the procedure of the activation of tags located within an interrogation zone is shown on FIGS. 1 and 2. A tag can be located randomly in points, for example, from Point 1 to Point 5, representing tags 1 to 5 locating at these points on a flat surface in a two-dimensional interrogation zone. If a tag is located at Point 1 and is transmitting a signal, the latter signal 10 reaches the antenna 11 with time delay t_{D} and is received by the antennae 11 and 12 with a time delay having a path length difference l₂₁. This path length difference is constant for any location of tags 1, 2 or 3, for example, on a hyperbolic curve 8.

Whereas in a reversed situation, namely, signals 14 and 15 are simultaneously transmitted by antennae 11 and 12 respectively, the signal 15 from antenna 12 will reach any tag located on the curve 8 with a delay of 1₂₁/C relative to the signal 14, where C is a signal propagation velocity in the given environment. But if the signal 15 is transmitted by 1₂₁/C earlier than the signal 14, then both signals will reach any tag 1, 2 or 3 simultaneously. Here and after only signal envelopes for radio frequency signals are shown.

When two signals 14 and 15 (in the form of pulses) are being transmitted, the signal 15 will be transmitted by the delay time (tₒ−t₂₁) relative to signal 14, if the path 7> the path 6, it indicates that the tags are located on the left of the middle line 16 or with the delay (tₒ+t₂₁), if the path 7<the path 6, it indicates that the tags are located on the right of the line 16, where the paths 6 and 7 represent the distances between the tag 1 and antennae 11 and 12 respectively, wherein tₒ=d/C; and d is the distance 9 between the antennae, and the duration Tₚ the pulses 14 and 15 is selected from Tₚ<<tₒ for determining the system's range resolution.

FIG. 2 shows the transmission of pulse signals 17 and 18 respectively from the antenna 12 for the tags 4 and 5. In such event, if the difference between the times in which these signals are received by tags 4 and 5 is equal to tₒ.

FIG. 3 shows the basic tag decoder in the system of the present invention, it consists of a delay device 24 and an AND circuit 25. Signals 14 and 15 enter the first input of the tag decoder in a propagation time of t_{D} through the antenna 11 to the tag 1, and then the second input through the delay device 24 to provide output signals 21 and 22 with the time delay of tₒ, and due to the selected temporal relations, the AND circuit 25 will create an output signal 23 at the moment when the first input has received signals 19 and 20 from the second antenna, and the second input has a signal from the first antenna with the time delay for the period tₒ. The output signal 23 is used as the signal for the activation of a tag located at any point of the hyperbolic curve 8.

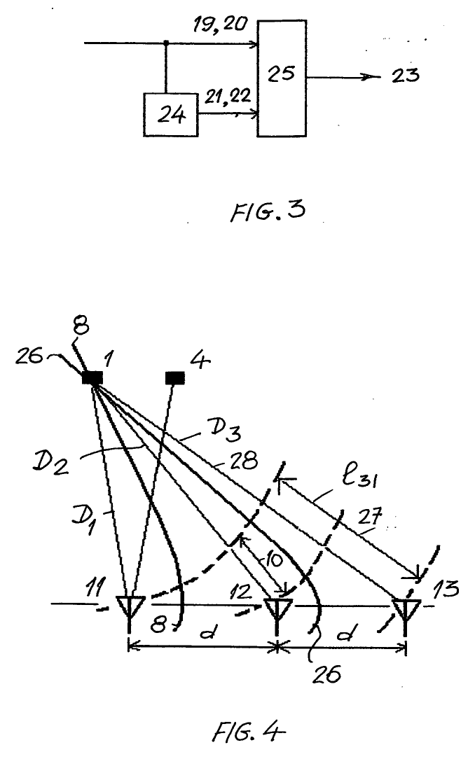

As shown in FIG. 2, the tags 4 and 5 are not located on the hyperbolic curve 8. In such instance, the AND circuit 25 will not produce the coincidence signal due to nonconformity of temporal relations between the signals and, as a result, these tags 4 and 5 will not be activated. The positions of pulses 17 and 18 for tags 4 and 5 show that it would not able to activate these tags. For the above reasons, two omni directional antennae would not provide a single-valued local activation of tags located on the flat surface. Therefore, to activate a tag located in a certain local interrogation zone 1 on the flat surface by antennae 11, 12 and 13 as shown in FIG. 4, it is necessary to use all these three antennae located along a straight line on the indicated flat surface, although generally antennae can be located randomly in a certain volume.

FIG. 4 shows that a tag will be activated at point 1 of a flat surface which will the unique point of intersection of two hyperbolic curves 8 and 26, where the curve 8 is determined by the antennas 11 and 12, and the curve 26 is determined by the antennae 12 and 13 respectively. The temporal

relations between the activating signals 14, 15 and 33 from antennas 11, 12 and 13 respectively are selected similar to the case examined above for the two antennae as shown in FIG. 1 and FIG. 3.

The operation of the deactivator at the antenna locations shown in FIG. 4, is illustrated in FIG. 5. As shown, signals 14, 15 and 33 are transmitted by antennas 11, 12 and 13 respectively with the delay relative to signal 14 for the time period (tₒ−t₂₁), if the delay periods D₂>D₁, or (tₒ+t₂₁), if the delay periods D₂<D₁. Likewise signal 33 is transmitted with the delay relative to signal 14 for the time period (2 tₒ−t₃₁), if D₃>D₁, or (2 tₒ+t₃₁) if the delay periods D₃<D₁. The delay of signal 33 relative to signal 15 can be calculated in the same manner.

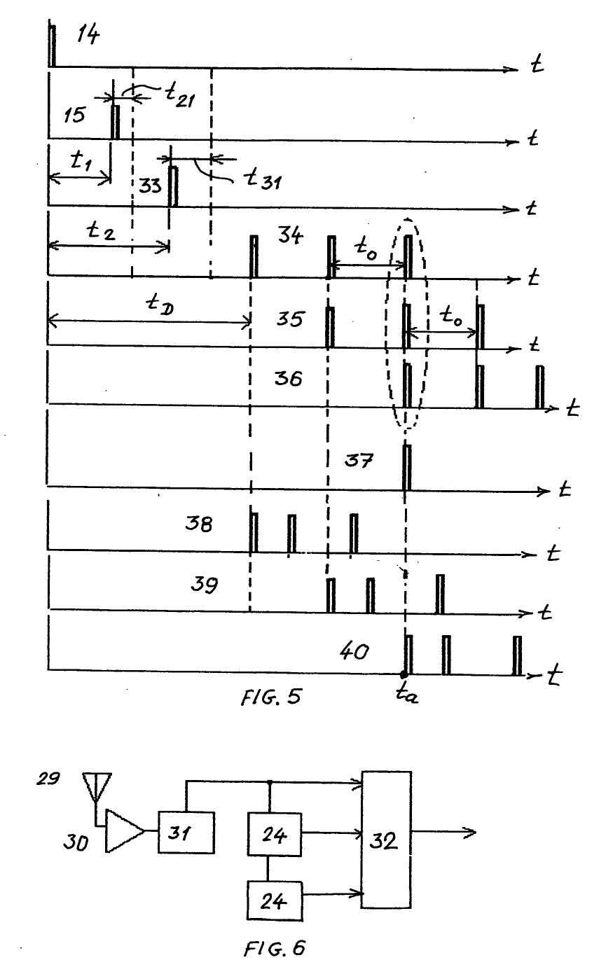

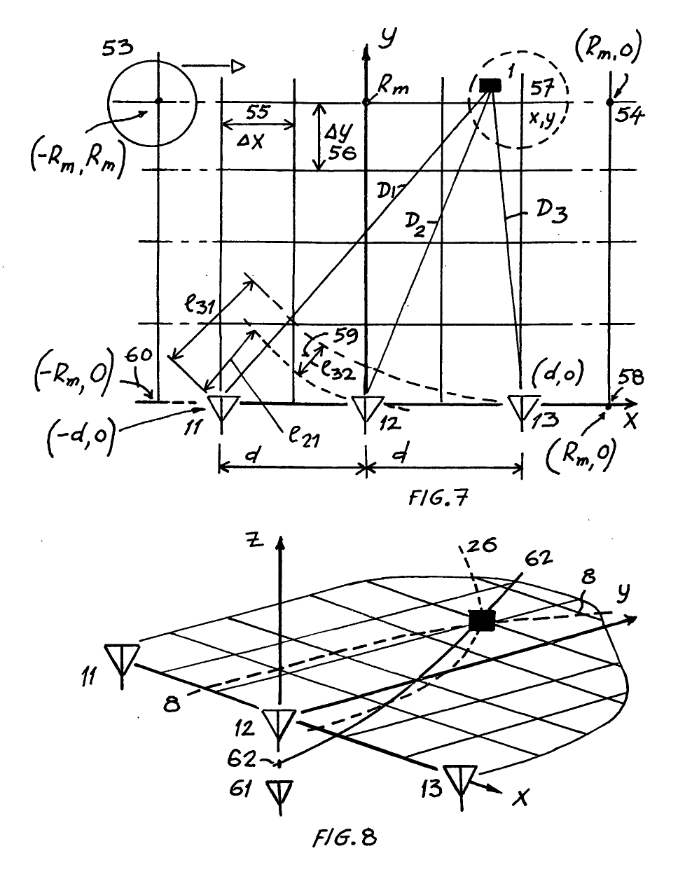

FIG. 5 also shows pulse signals 34 received at point 1 in FIG. 4 from antennas 11, 12 and 13, and the pulse signals 35 delayed by a time period of tₒ pulse signals 34, and pulse signals 36 delayed by the time period of 2tₒ from pulse signals 34. FIG. 6 shows the block diagram of the tag deactivator for processing these signals from the three antennae. The deactivator consists of an antenna 29, a preamplifier 30, a demodulator 31, two time delay devices 24 which provide a time delay period of tₒ, and an AND circuit 32. The pulse signals 34, 35 and 36 serially enter the first input, the second input and the third input of the AND circuit 32 respectively. FIG. 5 shows these signals coincide only at the moment tₐ with a resulting signal 37 appearing at the output of the AND circuit 32. The signal 37 activates a tag transmitter of the tag located at point 1 in FIG. 4. The group Signal 38 consists of pulses 14, 15 and 33. These pulses reach the first input of the AND circuit 32 of another tag located at point 4 in FIG. 4. On the other hand when group signals 39 and 40 are provided at the second and third inputs of the AND circuit 32, the AND circuit 32 will not produce any output signal, thus, no tag will be activated. Therefore, it is possible to activate any tag in a total tag interrogation zone by changing signal delays according to a specific rule well in advance at any point on the surface bearing antennae and tags.

FIG. 7 shows the reader interrogation zone in the Cartesian coordinates X and Y. To facilitate estimations, antennae 11 and 13 are placed symmetrically relative to the centre of the coordinates, at which an antenna 12 is placed. In the general case, antennae can be placed on the surface within the X and Y coordinates randomly. The search area has, for example, the shape of a rectangle defined by four points, namely point 60 (at coordinates −Rm, 0), point 53 (at coordinates −Rm, Rm), point 54 (at coordinates Rm, Rm), and point 58 (at coordinates Rm, 0), where Rm is the Read Range; X and Y are the coordinates of the present interrogation zone 57; [symbol] X (55), [symbol] Y (56) are the steps of scanning on coordinates X and Y respectively; d is the distance between the antennae; and l₃₁(27), l₃₂(59), l₂₁(10) are path length differences of these signals.

Scanning of the Local interrogation zone (indicated by a circle); is performed step-by-step starting from point 53 (−Rm, Rm) with the step size on X axis determined by value [symbol] X (the direction shown by pointer). For signals transmitted by a tag activator coder from reader in the form of amplitude-modulated pulse signals, for example, the dimensions of local interrogation zone are dependent on the pulse duration and it is determined by the range definition [symbol] X and [symbol] Y.

Wherein [symbol] X= [symbol] Y≈Tp×C.

D1, D2, D3 are distances from the antennas to the local interrogation zone.

To calculate parameters of the activating signals and delay times relative to each other, the following equations are used:
D1=✓(x+d)²+(y)², D2=✓(x)²+(y)², D3=✓(x−d)²+(y)²; (1)
t₂₁=(D2−D1)/C; t₃₁=(D3−D1)/C; t₃₂=(D3−D2)/C. (2)

To calculate greatest time interval of signal propagation from reader to interrogation zone borders the following equations are used:
TR=(Rm²+Rm²)/C=Rm✓/2/C. (3)

To activate a tag in the three-dimensional coordinates as shown in FIG. 8, it is necessary to use four antennas 11, 12, 13, and 61 while hyperbolic curves 8 and 26 determine the activated tag location in the X, Y plane, and the curve 62 determines the tag location in the three-dimensional space X, Y, and Z.

The tag activation described above is based on using activating signals in the shape of pulses. For the single-valued activation of a tag, differences between other signal parameters as frequency and phase can be used.

The main criteria of activation of a tag is the coincidence, at a certain moment of time, of signals transmitted by a reader, which have been previously selected according to the time, frequency or to the phase of transmitting signals. A coincidence must take place at a certain moment of time in the tag decoder.

Another method is by the comparison of time intervals between signals received by tag from antennas 11 and 12, in which the time of signal propagation between these antennas is tₒ.

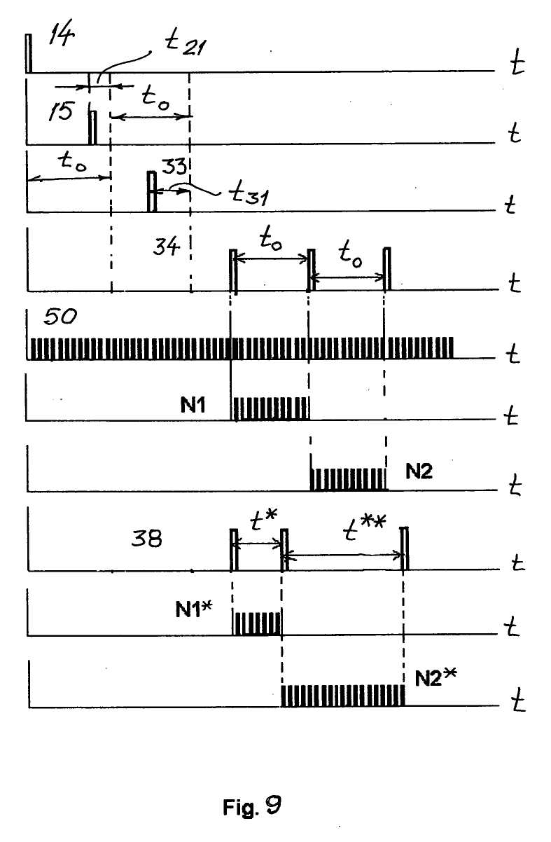

As shown in FIG. 9, signals 14, 15, and 33 transmitted by antennas 11, 12, and 13 respectively. Signal 15 is transmitted with the delay relative to signal 14 for the time (tₒ−t₂₁), if D2>D1 or (tₒ+t₂₁), if D2<D1. Likewise signal 33 is transmitted with the delay relative to signal 14 for (2tₒ−t₃₁), if D3>D1 or (2tₒ+t₃₁), if D3<D1; the group signal 34 are received from antennas 11, 12, and 13 at point 1 of FIG. 4. The group signal 50 from clock generator, filling the time interval between signals, is received by the tag, from antennas 11 and 12 in which the group signal N1 is received at the antenna 12 and the group signal N2 is received at the antenna 13 respectively. As shown, these group signals N1 and N2 coincide only for the tags located at point 1 of FIG. 4.

Thus, this coincidence is a main criteria of proper tags activation.

For other tags, such as tag 4 of FIG. 4 for example, the interval t* between signals arriving the tag from antennas 11 and 12 is not equal to interval t** between signals arriving the tag from antennas 12 and 13, it means the number N1* is not equal to number N2* respectively. At the same time, in order to avoid false activation, the time intervals between signals received from antennas 11 and 12, by the tag, 12 and 13 must be compared between itself and by the interval tₒ as well.

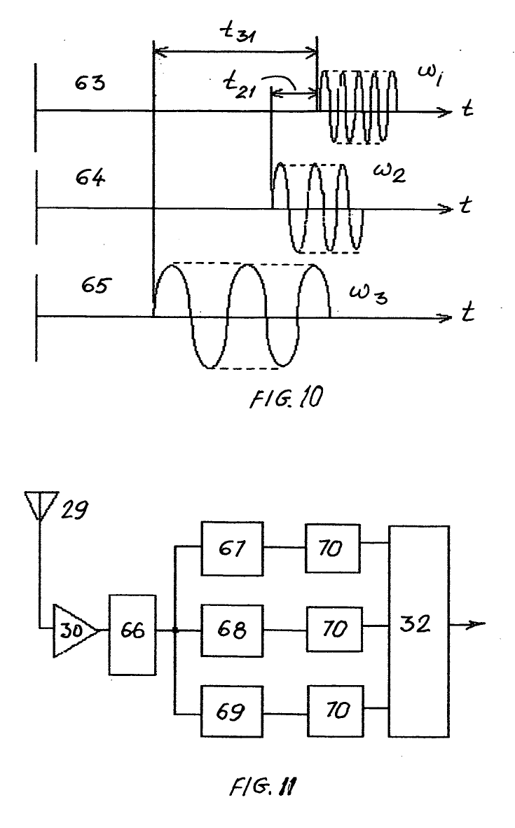

Another method of tag activation when carrier frequencies of activating signals are different in shown in FIG. 10 in which Signals 63, 64, and 65 with carrier frequencies ω1, ω2, ω₃ are transmitted by antennas 11, 12, and 13 respectively of FIG. 4. Delay times t₂₁, t₃₁ selected according to the rule of scanning of the total interrogation zone, for example, from left to right, from up to down as shown in FIG. 7. Then if tag is located in previously calculated zone with coordinates X,Y. Signals with carrier frequencies ω₁, ω₂, ω₃ to reach the tag simultaneously will be sent to tag antenna 29 with delays t₃₁ for signal 63, and (t₃₁−t₂₁) for signal 64, and without delay for signal 65 as shown in FIG. 10. These signals are amplified by preamplifier 30 as shown in FIG. 11 and converted in frequency converter 66 with heterodyne frequency ω₀. The sum of signals with new frequences ω₁−ω₀, ω₁+ω₀, ω₂−ω₀, ω₂+ω₀, ω₃−ω₀, ω₃+ω₀ pass through band-pass filters 67, 68, and 69 respectively tuned on frequencies ω₁−ω₀, ω₂−ω₀, ω₃−ω₀. Each of these signals passes through the envelope detector 70 and then is sent to the proper input of AND circuit 32. When the signals enter the circuit 32 simultaneously, the output signal from the AND circuit will activate the tag transmitter. For the tags which are not in point to be considered the signals are not sent to their inputs simultaneously because the delays t₂₁ and t₃₁ are calculated separately for each local interrogation zone and they differ from each other. So the AND circuits 32 of tag activator decoder will not generate any activation signal and no signal will be transmitted by the transponder.

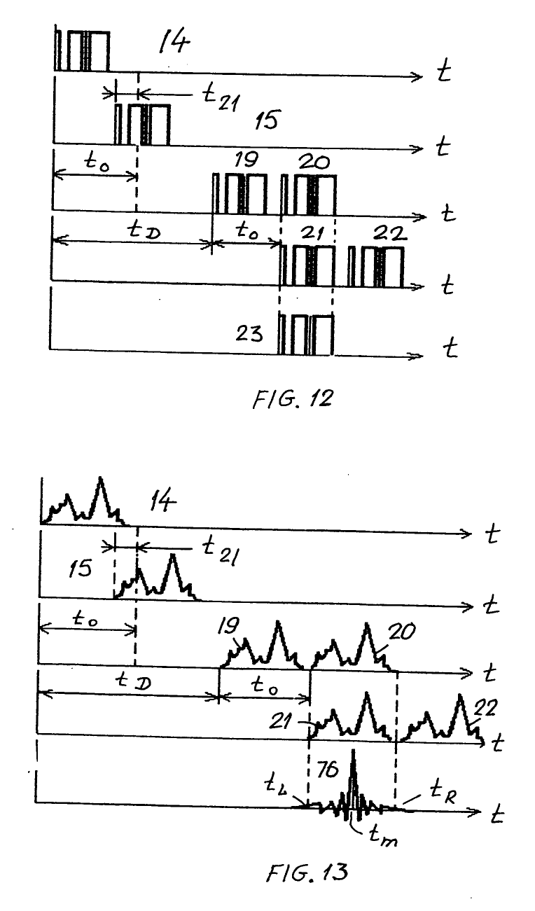

In some cases it is necessary to use transponders protected from unauthorized access. The modification of such systems is the method described above. This is the way of tag activation using differences in carrier frequency of activating signals transmitting by reader antennae. The other possible options of similar system are RFID systems with activating signals in the form of pulse train or quasi-random signals. Similar systems possess the larger reader range and interference protection because of increasing signal/noise ratio in comparison with single pulse systems. FIG. 12 shows signals in the system with the transmission of the activating signals in the form of a pulse sequence. The activating signal 14 consists, for example, of four pulses with the same or different duration and transmitted by the first antenna 11 of FIG. 1. Signal 15 represents a copy of the first signal shifted for time (tₒ−t₂₁) and transmitted by antenna 12. Signals 19 and 20 represent the sum of signals from antennas 11 and 12 received by tag activator decoder. This signal is sent to the direct input of the AND circuit 25 of FIG. 3 and then sent to the second input of AND circuit as well but delayed for time tₒ. Four pulses will appear in serially in the output of AND circuit 25 of FIG. 3. A block diagram of tag activator decoder for RFID system with activating signals in the form of pulses train is shown in FIG. 14. This block diagram is the development of tag activator decoder of FIG. 6 and differs from it by the introduction of a pulse counter 71. If number of pulses calculated by a counter in the output of AND circuit 32 concurs with the numbers of activating pulses from the tag activator coder, then the transponder control circuit 108 will create a signal to initialize the tag transmitter.

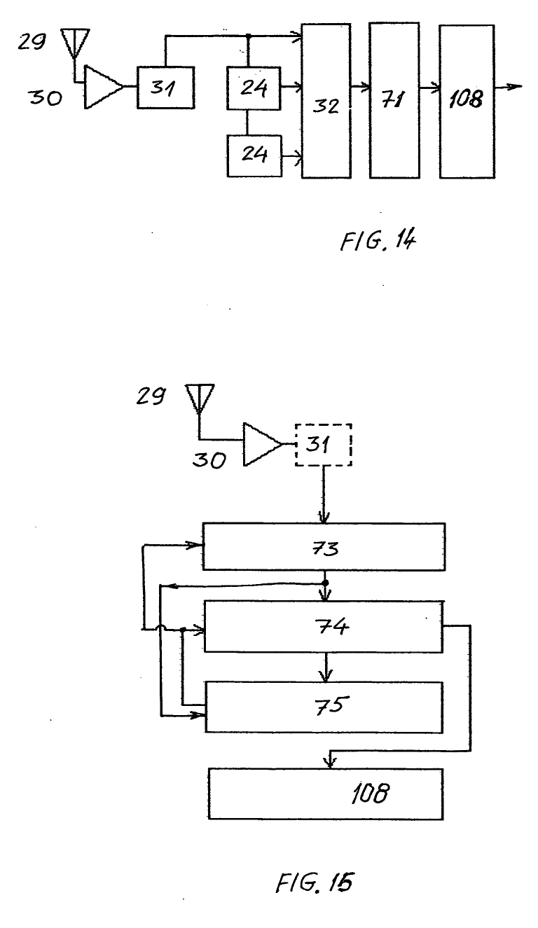

FIG. 13 shows signals in the RFID system with the activating signals in the form of quasi-random signals. The activating signal 14 represents, for example, harmonic signal modulated by randomized amplitude of limited duration and transmitted by the first antenna 11 of FIG. 1 in which only signal envelopes are shown. Signal 15 represents a copy of the first signal displaced for time (tₒ−t₂₁) and transmitted by antenna 12. Signals 19 and 20 represent a sum of signals from antennas 11 and 12 received by a tag activator decoder. Referring to FIG. 15 a block diagram of tag activator decoder for RFID system with quasi-random signals is illustrated. This tag activator decoder is similar to that shown FIG. 6 and differs from with the addition of the controller 74 and correlator 75. Signals 19 and 20 enter the input of signal processor 73 of FIG. 15. The signal processor 73 performs an analog-to-digital conversion of the input signals, and then transfers them to the first input of the controller 74 which transfers signals 19 and 20 to the first input of the correlator 75. Signals 21 and 22 are similar to signals 19 and 20 but delayed for a time period of tₒ to be sent to the second input of the correlator 75. A correlation function 76 as shown in FIG. 13 will appear from the output of the correlator 75 after the signals 19, 20, 21 and 22 have been processed. The function 76 has a maximum time of tₘ which corresponds to time (t_{R}−t_{L})/2 in which t_{R} and t_{L} are upper and lower borders of the time interval between the end of signal 20 and the beginning of signal 21. Signals 19 and 20 enter interrogation zone with a time delay of tₒ between signals 19 and 20, and signals 21 and 22 are coincided respectively. The correlator 75 of FIG. 15 evaluates the position of the maximum value of the correlation function 76 and sends a signal to the transponder control circuit 108 to initiate the tag transmitter. If a tag is located outside of the interrogation zone then the maximum of the the correlation function 76 will be shifted to the left or to the right depending on the tag position and the correlator 75 will not create and send signal to initialize the tag transmitter.

Another embodiment of the present system is the provision for protection from unauthorized access of the system with an electronic key. An electronic access key is realized as as a system that transmitting a specific signal to open the tag activator decoder before activation signals are sent out. Key signal enters the tag activator decoder in which it is compared with its duplicate in the tag activator decoder memory. If the key signal corresponds with the duplicate, the tag activator decoder will be opened for activation signals processing otherwise the receiver is locked.

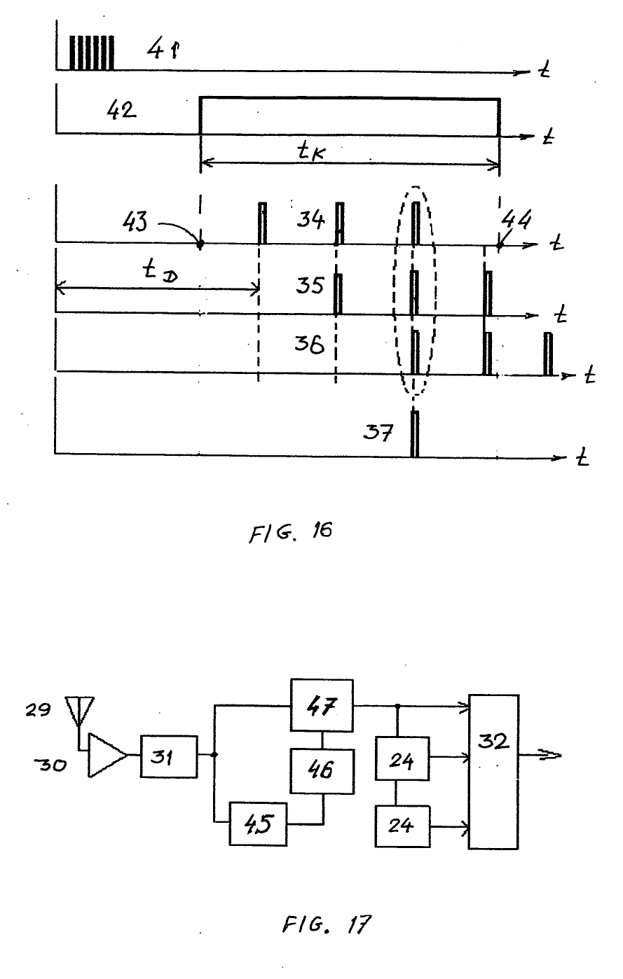

FIG. 16 shows signals in the RFID system with electronic key signals in the form of a pulse train 41. If the receiver of the tag is opened by the key signal, a specific signal 42 is created to open the tag activator decoder during the time interval tₖ sufficient to receive and process activation signals 34 to 37.

FIG. 17 shows a block diagram of the tag activator decoder with electronic key stages built-in. A pulse train 41 enters the input of a pulse comparator 45 to compare with its duplicate. In case of complete correspondence of the key signal with its duplicate, the comparator produces an output signal to activate circuit 46 that creates the signal 42. This signal 42 will open an electronic switch 47 to pass the activation signals 34 to 37 and to activate the tag transmitter as a result.

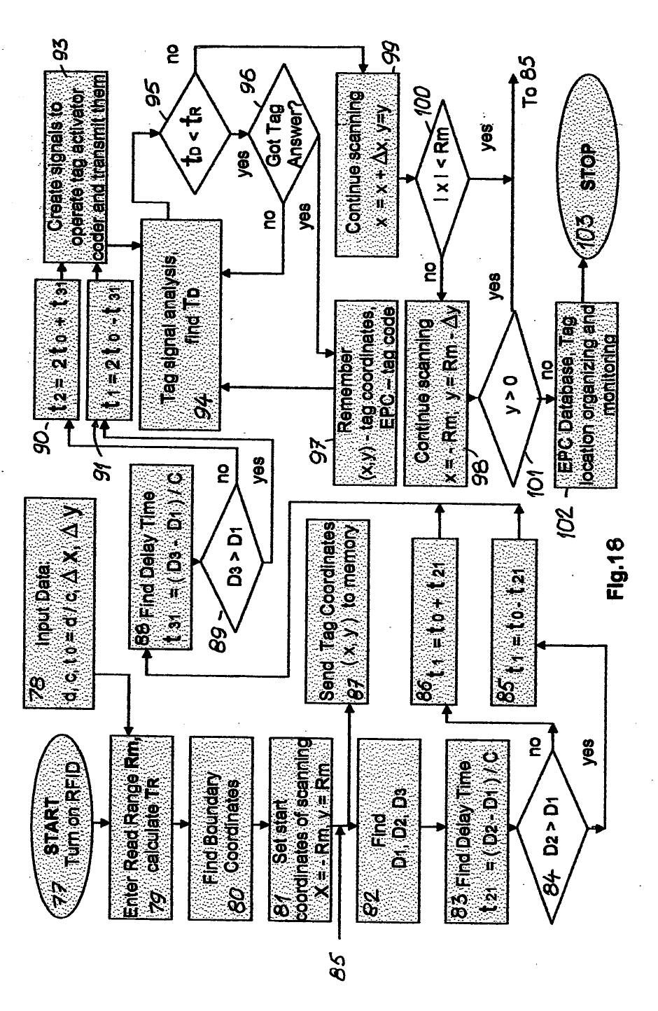

The overall operational algorithm of the RFID system of the present invention is shown in FIG. 18. The system assumes the technical parameters such as range Rₘ, range definition [symbol] X, [symbol] Y, location of antennae, and the speed of electromagnetic or ultrasound wave propagation, are all known for establishing a rule of scanning of total interrogation zone. The present algorithm foresees a survey of the total interrogation zone according to the rule: from left to right, from up to down as shown in FIG. 7. The first step 77 of the algorithm operation is to turn RFID system on. The next step 79 is entering the data of read range Rm, antenna aperture d, wave propagation speed C, steps of scanning Δx, Δy from a reader keyboard by the operator for calculating the time interval of signal propagation to a maximum remote point of interrogation zone T_{R} according to formula (3) and the parameter tₒ. Next step 80 is to set the total interrogation zone boundaries, thereafter step 81 calculates the start point of area scanning (−Rₘ, Rₘ). Step 85 calculates the ranges D1, D2, and D3 from reader antennae to local the center of the interrogation zone according to formulas (1). The time delay t₂₁ between signals 14 and 15 as shown in FIG. 5 is determined by step 83. Depending on the proportion between D1 and D2 estimated by step 84, a time delay t₁ as shown in FIG. 5 between the signals transmitted by antennas 11 and 12 is chosen and estimated by steps 85 and 86. Similar delay t₂ between signals 14 and 33 of FIG. 5 is estimated and calculated by steps 88, 89, 90 and 91. The next step 93 is the creation of a pulse train to operate transmitter signals of tag activator coder in accordance with the calculated delays. The values of time delays are also used in the reader intake for the creation of adaptive antenna consisting of three separate antennae. In accordance with these values, it is introduced a time shift between signals received by antennas 11, 12, and 13 to compensate the delays of the signals caused by different time of propagation of these signals from the tag to each antenna and, finally, to provide in-phase or coherent receiving of tag signals to the reader. For example, a signal received by antenna 2 shifts relative to the signal received by antenna 1 by time t₂₁, a signal received by antenna 3 shifts relative to the signal received by antenna 1 by time t₃₁ which creates a reader coherent receiver. The steps 94, 95, and 96 evaluate the time t_{D} passed after the beginning of transmitting the activating signal up to the current time and are implemented as a timer for comparing time t_{D} with a time t_{R} relative to the time of propagation of signals to maximum remote point of the total interrogation zone. If after transmitting of the activating signals by tag activator coder an answer signal from tag is not received by the reader during the time interval t_{R}, it means that there is no tags in the survey local interrogation zone and the next step in scanning of total interrogation zone would be performed. The situation, in which tag signals received by reader but the time of survey of interrogation zone is not expired, is implemented by steps 94, 95, and 96. Then the scanning of zone continues in the above order to receive a signal of other probable tag or tags located in the same zone. Step 97 saves the tag coordinates and its electronic codes for the creation of database, monitoring of data and the item images of the display. Step 99 creates the next step of scanning the search area by increasing the current meaning of coordinate X to the value ΔX, after that a control of program is transferred to the block 82 for organizing of next cycle of scanning of the search area. If a new meaning of current coordinate exceeded the bound of total interrogation zone resulting from the analysis in step 100, step 98 will shift the coordinate X to left in a distance with X=−Rm and the coordinate Y will shift for one step down with a distance of Y=Rm−ΔY. Step 101 analyzes the current value of the Y coordinate. If this value when shifted by a step ΔY became negative then the survey of the search area is considered completed, and step 102 makes a creation and ordering of database, data monitoring and printing. Step 103 stops the RFID device after the total interrogation zone is completely scanned. The above described steps 77-101 are implemented by an arithmetic and logic program microprocessor in the control loop.

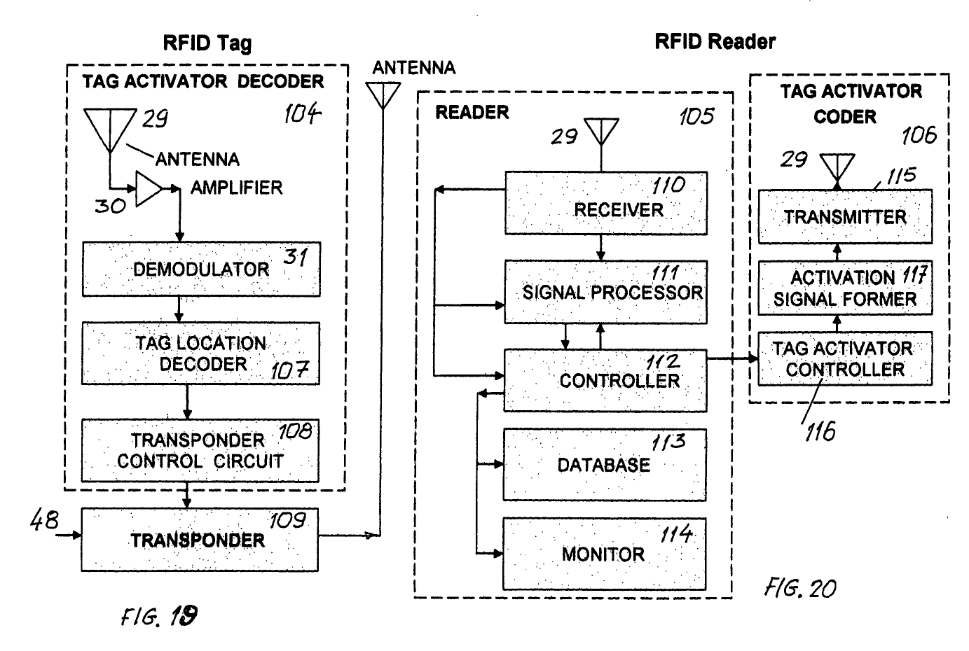

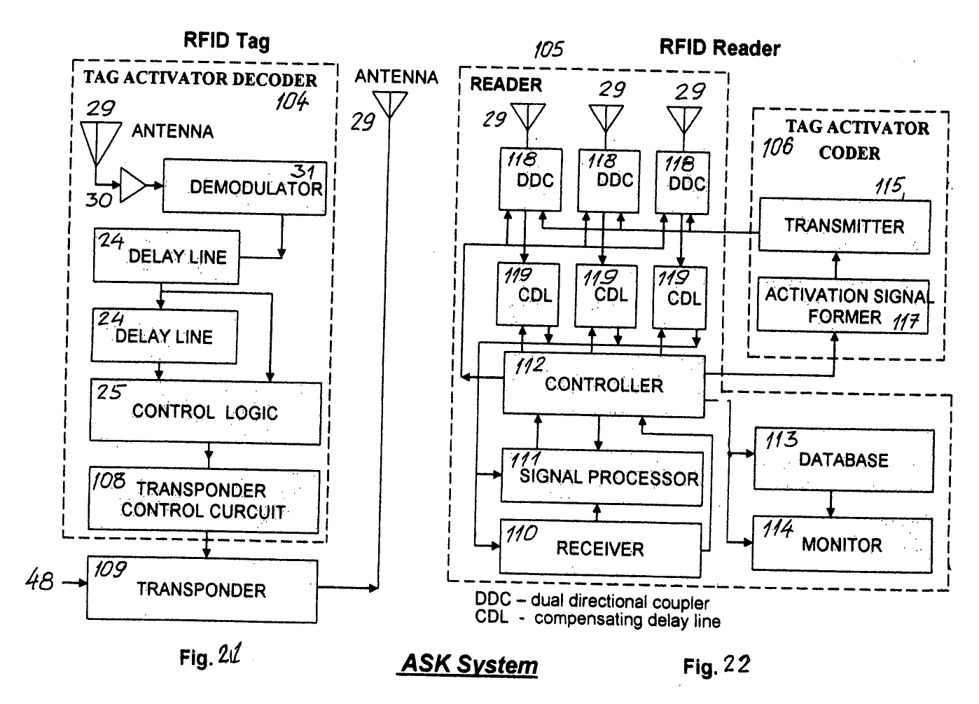

Referring to FIGS. 19 and 20, a block diagram of RFID system is illustrated. It consists of a RFID reader 105 and RFID transponder 109 and a channel called tag activator for activating the transponder. A tag activator coder 106 is implemented in the reader 105 and a tag activator decoder 104 is implemented in a tag to control the transponder 109. The reader for receiving the tag information signal consists of an antenna 29, a controller 112 operating for transmission and reception of signals, creation of control and information signals, data accumulation and monitoring, signal processor 111, the reader receiver 110, the database 113 and monitor 114 for storage and the display of digital, text and graphic information about the transponders and the code, location etc., of these components.

The tag activator coder 104 consists of a tag activator controller 116, an activation signal former 117 and a transmitter 115. The tag activator controller 116 calculates the signal activation parameters for creating signals in accordance with a rule of total interrogation zone scanning to operate the transmitter 115 and the transmit activation signals by the antennae in the direction of activating tag.

Tag activator decoder 104 consists of an antenna 29, a preamplifier 30, a demodulator 31 for obtaining a signal envelope, a tag location decoder 107 for tag activation signals processing and to create input signal if a tag is supposed to be activated. A transponder control circuit 108 is provided for operating the transmitter of the transponder 109 which is activated when the transponder is connected to a battery with the operation of an electronic switch. The output of the transponder 109 is connected to an antenna for transmitting an information signal containing the tag electronic code. Each transponder is provided with active power supply such as a built-in buttery or a passive power supply 48. If the transponder is within the range of the reader, a power supply will be induced in the transponder antenna by the electromagnetic or ultrasound field strength.

The transmitter 115 of tag activator coder, the activation signal former 117, controller 116, the antenna 29, preamplifier 30, demodulator 31, tag location decoder 107, transponder control circuit 108, other elements of reader 105 and transponder 109 can be implemented in analog hardware, digital hardware and software or in their combination.

FIGS. 21-22 show a block diagram of RFID system which use amplitude modulated signals, namely, single pulses as activating ones named ASK—Amplitude Shift Keying System consisting of a RFID couple of reader 105 and transponder 109, and a channel comprises of two devices to activate the transponder, the tag activator coder 106 and the tag activator decoder 104. The operation of this system is similar to that described above for FIGS. 19 to 20. But, in addition to that described above, in this system the reader output stages such as that from the omnidirectional antennae 29 and dual directional couplers 118 are used to transmit activation signals from the tag activator coder 106 outward to receive tag signals, as well as to provide power to the tag transmitter. The dual directional couplers 118 uncouples the transmitter and receiver, compensating delay lines 119 for creating a coherent receiver of transponder signals by control of signal delays, controller 112 for controlling transmitting, receiving and creation of activation and information data signals, and accumulation and monitoring of data. The receiver 110 receives RF signal and sends it to the signal processor and controller 112. A controller creates, operates and monitors data consisting of digital, text and graphic information from transponders in the database storage 113 and monitor 114. The tag activator coder 106 consists of an activation signal former 117 and transmitter 115. The controller 112 calculates and creates signals to operate signal former 117. Radio frequency signals from former 117 enter transmitter 115 to radiate activating pulses outward in accordance with rules of interrogation zone scanning. The tag activator decoder 104 consists of antenna 29, preamplifier 30 of RF activating signals, demodulator of signals 31, delay lines 24 and control logic 25. The control logic 25 compares activating signals as described above for that shown in FIG. 6. The control logic 25 sends a signal to the transponder control circuit 108 which controls the transmitter of transponder 109 by operating, for example, an electronic switch connecting the battery to transponder to radiate information signal from the transponder outward to the reader. Each transponder is provided with active or passive power supply 48.

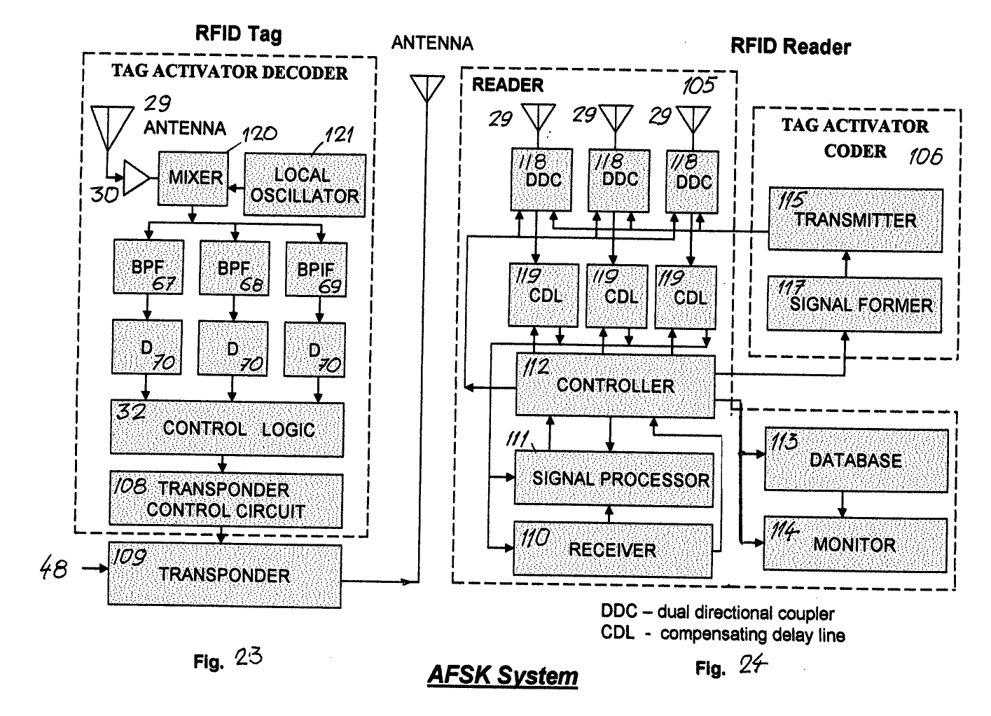

FIGS. 23-24 show a block diagrams of RFID system of the present invention which use amplitude modulated signals, namely, single pulses as activating ones with different carrier frequencies, called AFSK—Amplitude and Frequency Shift Keying System consisting of a RFID couple including reader 105 and transponder 109 and a channel of transponder activation having tag activator coder 106 and tag activator decoder 104. Reader output stages such as omnidirectional antennae 29, dual directional couplers 118 are used for transmitting activation signals from the tag activator coder 106 outward, to receive transponder signals, as well as to provide transponder transmitter with power. The reader consists of compensating delay lines 119 that create a coherent receiver of transponder signals by control of signal delays, controller 112, signal processor 111, receiver 110, database 113 and monitor 114. Dual directional couplers 118 uncouple the transmitter and receiver. In operation, the receiver 110 receives the RF signal and forwards it to signal processor and controller 112. The controller 112 creates, operates and monitors data including digital, text and graphic information from transponders in the database storage 113 and monitor 114.

Tag activator coder 106 consists of activation signal former 117 and transmitter 115. Controller 112 calculates and creates signals to operate the signal former 117. The former 117 generates three pulses with different carrier frequencies and variable time of transmitting in accordance with a total interrogation zone location. Transmitter 115 sends the activating pulses to proper antennae 29 to radiate them to a search zone. The tag activator decoder 104 consists of antenna 29, preamplifier of RF for activating signals 30, mixer 120, local oscillator 121, band pass filters 67, 68, and 69, adder 122, envelope detector 70, control logic 32, and transponder control circuit 108. Radio frequency signals from the antenna 29 enter the preamplifier 30 input. Mixer 120 converts the carrier frequencies of the activating signals down by mixing them with the signal from a local oscillator 121. Band pass filters 67, 68, and 69 select and pass low frequency signals in accordance with initial position of each activating signal from the tag activator coder. Envelope detectors 70 create envelopes of activating signals which are fed to the inputs of control logic 32 after summing it in the adder 122. The control logic 32 compares the activating signals and create an output signal to control the transmitter of the transponder 109 which is actuated by operating an electronic switch for connecting a battery to the transponder so as to radiate the information signal from the transponder outwards to the reader. Each transponder is provided with active or passive power supply 48.

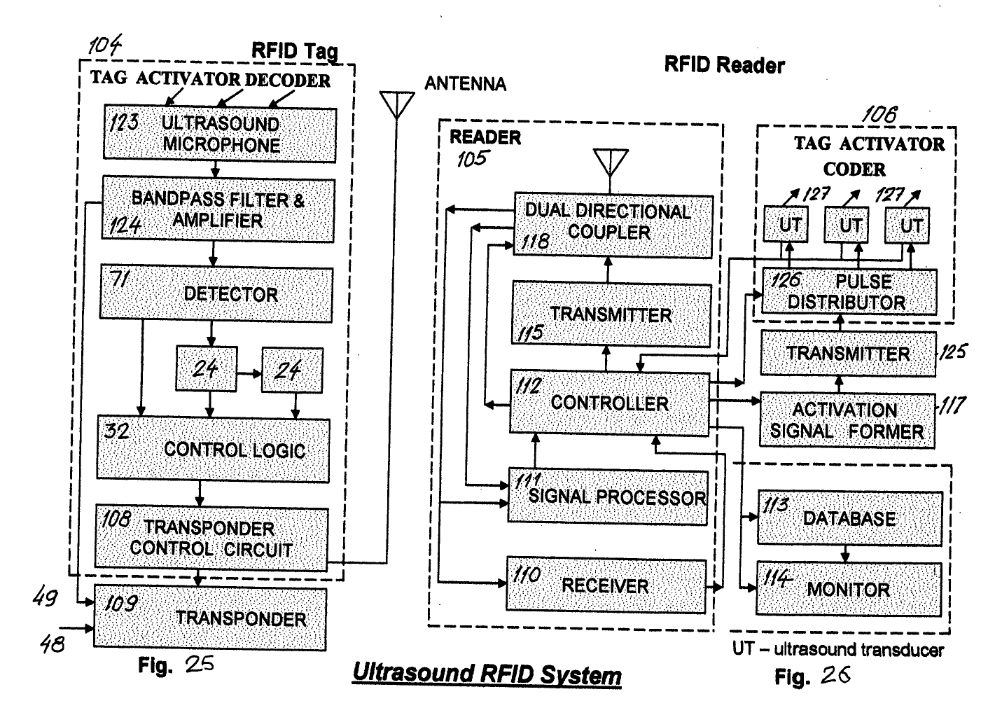

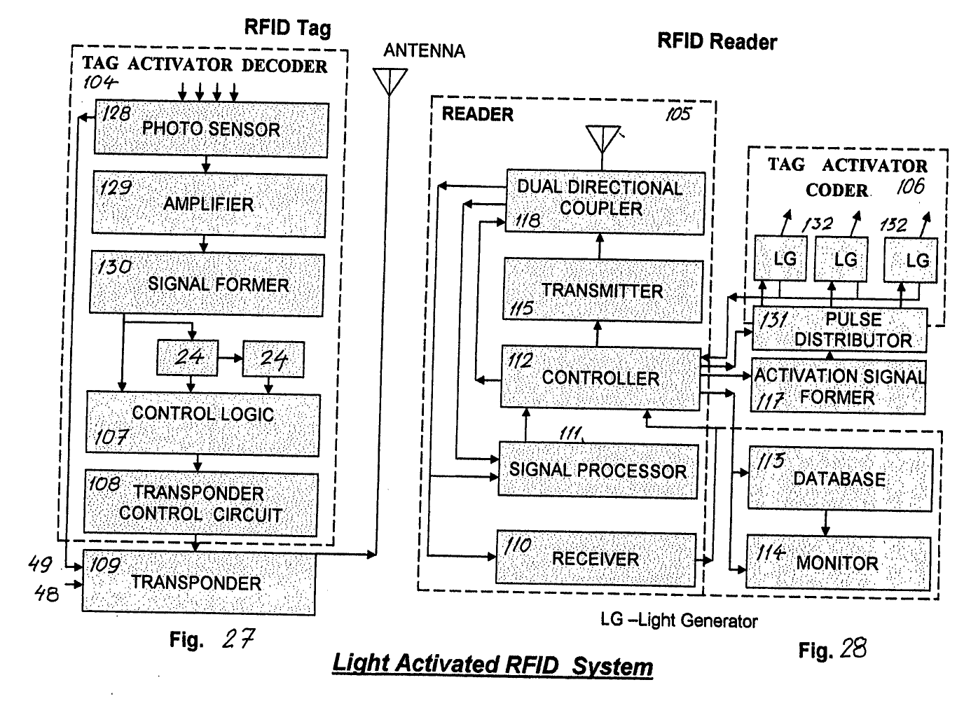

FIGS. 25-26 show block diagrams of the RFID system of the present invention, which uses amplitude modulated ultrasound pulses as activating signals named This ultrasound embodiment consists of a RFID couple including the reader 105 and transponder 109 and a channel of transponder activation having tag activator coder 106 and tag activator decoder 104. The reader consists of at least one radio frequency antenna 29, dual directional coupler 118, controller 112, signal processor 111, receiver 110, transmitter 115, database 113 and monitor 114. The tag activator coder consists of activation signal former 117, transmitter 125, pulse distributor 126 and an ultrasound transducers 127. In operation, the activation signal former 125 creates activating pulses 14, 15, and 34 as shown in FIG. 5 in accordance with commands from the controller 112 and sends them to the transmitter 125. The pulse distributor 126 distributes activating signals to appropriate ultrasound transducers 127 for transmitting them to tag interrogation zone. The tag activator decoder consists of an ultrasound microphone 123, preamplifier and band pass filter 124, envelope detector 71, delay lines 24, control logic 32, and transponder control circuit 108. The ultrasound microphone 123 receives ultrasound pulses and converts them into electrical signals. Band pass filters and amplifier 124 amplify and select activating signals, and the envelope detector 70 creates activating pulse envelopes which are fed to the inputs of control logic 32 after being delayed by the delay lines 24. The control logic 32 compares activating signals and creates an output signal for controlling the transmitter of transponder 109 after actuating electronic switch for connecting a battery to the transponder to radiate information signal from the transponder outward to the reader. Each transponder is provided with active or passive power supply 48. Another way to provide transponder of ultrasound RFID system with power supply is to obtain supply voltage 49 from the ultrasound microphone output 123. The reader may include optionally a RF transmitter 115 to provide a tag with power supply by induced electromagnetic radiation.

FIGS. 27-28 in combination shows a block diagram of a Light Activated system (LA RFID) according to the present invention, which uses amplitude modulated light pulses as activating signals. The system consists of RFID couple having a reader 105 and transponder 109 and a channel of transponder activation including tag activator coder 106 and tag activator decoder 104. A reader consists of at least one radio frequency antenna 29, dual directional coupler 118, controller 112, signal processor 111, receiver 110, transmitter 115, data base 113 and monitor 114. The tag activator coder consists of activation signal former 117, pulse distributor 131, and light generators 132. Activation signal former 117 for creating activating pulses 14, 15, 34 in accordance with commands from controller 112 as shown in FIG. 5 and forwards them to the pulse distributor 131. The pulse distributor 131 distributes activating signals to initialize light emission of appropriate light generator 132 for transmitting them to the tag interrogation zone.

The tag activator decoder consists of receiver includes photo sensor 128, amplifier 129, signal former 130, delay lines 24, control logic 32, and transponder control circuit 108. A photo sensor 128 receives light pulses and converting them into electrical signals. An amplifier 129 amplifies the activating signals and forwards them to the signal former 130. Former 130 operates as a low pass filter, for example, for creating activating pulse envelopes, which are fed to the inputs of the control logic 32 after having been delayed at delay lines 24. The control logic 32 compares the activating signals to create an output signal for controlling the transmitter of the transponder 109 by operating an electronic switch for connecting the power supply battery to the transponder. Each transponder is provided with an active or passive power supply 48. Another way to provide transponder of Light Activated RFID system with power supply is to obtain supply voltage 49 from photo sensor 128 which converts light into electrical power. The reader may optionally include a RF transmitter 115 to provide the tag with power supply by induced electromagnetic radiation. This is a simple way to activate a selected tag by merely sending a narrow beam of light at the tag location. Some optional elements such as the pulse distributor 131, delay lines 24, control logic 107 can be omitted from the Light Activated RFID System block diagram. Another logical device consisting of a controller for comparing envelopes of signals for turning on selected RFID tags by reference level must be provided in tag activator decoder.

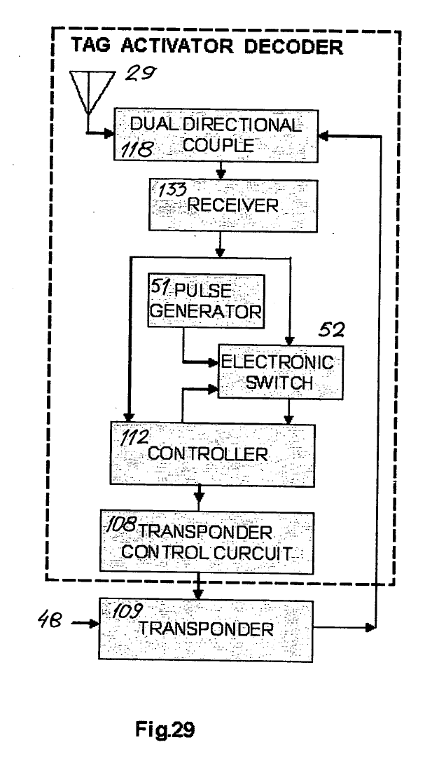

FIG. 29 shows a block-diagram of the tag activator decoder for the above described RFID Reader as shown in FIG. 22, in which the method of selective tag activation is provided by receiving signals from reader antennas by a tag and comparing of time intervals between signals and by specific interval. The tag activator decoder 104 consists of an antenna 29, dual dual directional couple 118 and receiver 133, including preamplifier of RF activating signals and their demodulator, pulse generator 51, electronic switch 52, controller 112, transponder control circuit 108, and transponder 109. The pulse generator 51 produces the clock pulses 50 as shown in FIG. 29. The controller operates the electronic switch 52 to create pulse trains N1 and N2 by opening and closing depending on signals from the receiver 133. The controller 112 compares the numbers of clock pulses N1 and N2 between itself and by interval tₒ as well and depending on whether the numbers N1 and N2 correspond to each other and with number Nₒ (specific number calculated by dividing tₒ by the interval between clock pulses), the controller 112 sends a signal to the transponder control circuit 108. Circuit 108 controls the transmitter of the transponder 109 such as by the operation of an electronic switch for connecting a battery to the transponder to radiate information signal from the transponder outward to the reader. Each transponder is provided with active or passive power supply 48.

It is to be understood that variations and modifications of the present invention can be made without departing from the scope of the invention. It is also to be understood that the scope of the invention is not to be interpreted as limited to the specific embodiments disclosed herein, but only in accordance with the appended claims when read in light of the forgoing disclosure.

What is claimed is:

1. A method for the identification and location of radio frequency identification RFID tags having configurations and locations, comprising:
forming signals for activating selected RFID tags, based on reader antennas and said tags configurations and locations;
transmitting signals for activating of said selected RFID tags in an interrogation zone of a reader;
receiving signals for activating said selected RFID tags in said interrogation zone of a reader;
processing signals for activating said selected RFID tags in said interrogation zone of a reader to determine if tags must be activated;
forming a signal to operate transponder of an activated tag;
transmitting a RFID transponder signal from said activated tags to a reader;
receiving a RFID transponder signal by said reader;
processing an RFID transponder signal by said reader.

2. A method according to claim 1 wherein includes the steps of selecting location and coordinates of said interrogation zone of said reader;
selecting dimensions of tag zone equal to dimensions of said tag;
selecting of a start point of scanning of said interrogation zone of said reader;
calculation of signal parameters for activation of tags for each tag zone;
calculating time required for scanning said each tag zone;
creating of signals for activating selected RFID tags in accordance with calculated signal signal parameters for each said tag zone;
transmitting activation signals for activating said selected RFID tags;
receiving said activation signals for said selected RFID tags in said tag zone;
processing said activation signals for activating said selected RFID tags in said tag zone and determining activation of a selected tag;
transmitting a signal information by a transponder of an activated tag;
receiving said signal information by said reader;
said processing a RFID transponder signal including processing said signal information by said reader and reading said tag information;
creating a tag data consisting of tag coordinates, an electronic code, description of product whereon said tag is provided, and other information data;
entering of said tag data in a RFID reader memory;
calculating time lapse between beginning of signal transmission for activating said selected RFID tags and a present time;
comparing said time lapse with time of scanning in said tag zone;
shifting to a selected next tag zone location, when said time lapse is more than said time of scanning of said tag zone;
repeating above steps until scanning operation of the entire said interrogation zone has been accomplished;
organizing, storing and monitoring tag data including coordinates, electronic codes, description of articles bearing said tags, graphic view of said articles, security and service information data.

3. A method according to claim 2 wherein a number of scanning operation of said tag zone is predetermined, and said scanning said tag zone is repeatedly in accordance with said predetermined number of scanning operation.

4. A method according to claim 3 wherein a tag zone is set in a selected center of said interrogation zone of said reader, and scanning is repeated by increasing dimensions of said tag zone in number of times according to a value optimizing probability of tag detection, identification of its electronic code and determination of tag location, until tag information signal is received by said reader.

5. A method of claim 2 wherein said signals activating said selected RFID tags are pulses with fixed RF carrier having an amplitude shift key (ASK), said received signals are demodulated at said tag locations, and signal envelopes are processed in sequence in a plurality of channels including a first channel for receiving an initial signal, a second channel for receiving a second signal delayed by a specific time from said initial signal, and a third channel for receiving a third signal delayed by twice said specific time wherein said specific time is dependent on an antenna aperture and tag zone locations, and said number of channels is equal to number of antennae, and said signal envelopes are compared with a duplicate of said signal envelopes by time of matching, and an actuation signal for turning on said transponder is created when said signal envelopes and duplicate of said envelopes in all said first channel, said second channel and said third channel correspond with one another simultaneously, said actuation signal turns on said transponder for transmitting information signal by transponder.

6. A method according to claim 2 wherein said signals for activating said selected RFID tags are pulses with own RF carrier of amplitude and frequency shift keying (AFSK) and said received signals at said tag locations are amplified and mixed, and RF filtered for creating signal envelopes, and said signal envelopes are detected and compared with duplicate signal envelopes by time of matching, and an actuation signal is created for turning on said transponder when said signal envelopes and duplicate signal envelopes corresponds with one another in all said first channel, said second channel and said third channel simultaneously, said actuation signal turns on said transponder for transmitting information therefrom.

7. A method according to claim 2 wherein said signals for activating said selected RFID tags are pulse train with RF carrier having amplitude shift keying (ASK) and a number of pulses is predetermined, and said received signals at said tag locations are processed with a plurality channels in a sequence with an initial signal is first received in a first channel, and a second signal is received in a second channel delayed by a specific time, and a third signal received by a third channel delayed by twice said specific time wherein said specific time is dependent on an antenna aperture and said tag zone, and number of plurality of channels is equal to the number of antennae, pulse train of envelopes of signals for activating of said selected RFID tags is created in each of said channel, said pulse train of envelopes are compared with one another by time of matching, and the matching number of pulses is calculated, and said matching number is compared with said predetermined number of pulses for creating an actuation signal to turn on said transponder when said calculated number of pulses matches with said predetermined number of pulses whereby said actuation signal turns on said transponder to transmit said information signal.

8. A method of claim 2 wherein said signals for activating of said selected RFID tags are pulse with RF carrier and quasi-random envelope, and said received signals at said tag locations are processed with a number of a plurality of channels sequentially with a first signal received in a first channel, a second signal received in a second channel and delayed by a specific time, and a third signal received in a third channel and delayed by twice said specific time wherein said specific time is dependent on an antenna aperture and a tag zone, and said number of plurality of channels is equal to the number of antennae, and signals are compared between themselves with correlating, a positions of top peak of cross correlation function are estimated for each couple of signals, and an actuation signal of turning on said transponder is created when the positions of top peaks of cross correlation function for each couple of signals between couples by time of matching are corresponding with one another whereby said actuation signal turns on said transponder to transmit information signal therefrom.

9. A method according to claim 2 wherein said signals for activating of said selected RFID tags are pulses with fixed RF carrier having amplitude shift keying (ASK), said received signals at said tag location are demodulated for signal envelopes creation, and time intervals between envelopes of said signals are provided with clock pulses with every interval between said clock pulses counted, and compared between one another and with a specific number calculated by dividing a time interval between activating pulses for an infinite tag location by interval between clock pulses, and an actuation signal for turning on said transponder is created upon under correspondence of all numbers whereby said actuation signal turns on said transponder for transmitting information signal therefrom.

10. A method according to claim 9 wherein said specific time delays for said tag information signal received by reader antennas are calculated for each antennae in accordance with location of tag interrogation zones, and information signals from tags received by said reader is delayed by said specific time in each reader antennae, and delayed signals are summed up whereby overall signal is processed by said reader.

11. An apparatus for identification and location of a plurality of RFID tags, comprising:
means for forming signals for turning on selected RFID tags;
means for transmitting signals for activating of said selected RFID tags in an interrogation zone of a reader;
means for receiving signals for activating said selected RFID tags in said interrogation zone of said reader;
means for processing of signals for activating of said selected RFID tags in said interrogation zone of said reader to determine if tags to be activated;
means for forming signals to operate RFID transponder of an activated tag;
means for transmitting RFID transponder signals to said reader;
means for receiving an RFID transponder signals by said reader; and
means for processing an RFID transponder signals by said reader.

12. An apparatus according to claim 11 wherein said means for forming signals for turning on said selected RFID tags comprising:
means for selecting of location and coordinates of an interrogation zone of said reader;
means for selecting dimensions of a tag zone;
means for selecting of a start point of scanning of interrogation zone of said reader;
means for calculating parameters of signals for turning on of said selected RFID tags for each said tag zone;
means for calculating time of scanning of said tag zone;
means for creating of signals for activating said selected RFID tags in accordance with calculated signals parameters for each said tag zone;
means for transmitting signals for activating said selected RFID tags;
means for receiving said signals for activating said selected RFID tags;
means for processing said signals for activating said selected RFID tags in said tag zone and to determine activation of a present tag being interrogated;
means for transmitting an information signal by transponder of an activated tag;
means for receiving said information signals by said reader;
said means for processing said selected RFID with transponder signal by said reader including means for processing said information signals by said reader and reading of tag information;
means for creating of tag data consisting of tag coordinates, electronic code of said tag, and description of product bearing said tag and other related data;
means for entering said tag data into memory of said RFID reader means for calculating of time passed from the beginning of transmitting of said signals for turning on said selected RFID tags up to present time;
means for comparing of time passed from the beginning of radiating of signals for turning on said selected RFID tags up to present time with time of scanning of said tag zone;
tag zone location to a next tag zone location, when time passed for shifting passed from the beginning of transmitting of signals for turning on selected RFID tags is more then time of scanning of said tag zone,
means for repeating above steps of signals for turning on selected RFID tags and information signals creation, transmission, receiving and processing until scanning of the entirety of said interrogation zone of said reader is completed;
means for organizing, storing and monitoring tag data;
means for providing said RFID tag with power supply.

13. An apparatus according to claim 12 including means for scanning said tag zone for a predetermined number of times.

14. An apparatus according to claim 13 including means operativ for calculating dimensions of said tag zone, and means operative for controlling scanning of said and tag zone within said dimensions.

15. An apparatus according to claim 14 wherein said means for providing RFID tag with power supply include means for transmitting a RFID tag power supply signal to a selected RFID tag.

16. An apparatus according to claim 14 wherein said means for providing RFID tag with power supply includes means for supplying power signals for activating selected RFID tags.

17. An apparatus according to claim 14 wherein said means for providing RFID tag with power supply includes means for supplying said tag with power from a built-in battery.
